(19) United States
(12) Patent Application Publication
(10) Pub. No.: US 2017/0355408 A1
(43) Pub. Date: Dec. 14, 2017

(54) DEVICE ALIGNMENT TOOL AND METHOD

(71) Applicant: MOBILEYE VISION TECHNOLOGIES LTD., Jerusalem (IL)

(72) Inventor: Udi LEVY, Jerusalem (IL)

(73) Assignee: Mobileye Vision Technologies Ltd.

(21) Appl. No.: 15/486,697

(22) Filed: Apr. 13, 2017

Related U.S. Application Data
(60) Provisional application No. 62/347,736, filed on Jun. 9, 2016.

(51) Int. Cl. B62D 65/06; B60R 11/04; B60J 1/00

(52) U.S. Cl. CPC B62D 65/06; B60J 1/005; B60R 11/04

(57) ABSTRACT

A device alignment tool is disclosed. The alignment tool may have a frame. The alignment tool may also have at least one connector attached to the frame. The at least one connector may be configured to releasably attach the frame to a surface of a windshield. The alignment tool may have at least one link member. The link member may be fixedly attached to the frame at one end. The link member may also have an edge connection member at the opposite end. The edge connection member may be configured to engage with at least one edge of the windshield. The at least one link member may also have an adjustable length. The at least one link member may be configured to releasably attach the frame to the at least one edge of the windshield.

### RELATED APPLICATION

This application is based on and claims benefit of priority of U.S. Provisional Patent Application No. 62/347,736, filed on Jun. 9, 2016, which is incorporated herein by reference.

### TECHNICAL FIELD

The present disclosure relates generally to a device alignment tool, and, more particularly, to a device alignment tool and method.

### BACKGROUND

Modern vehicles often have a variety of devices attached to an inside surface of the windshield. For example, vehicles may be equipped with one or more cameras or sensors that may provide images or other information used to control a movement of the vehicle. The cameras or sensors may be directly attached to an inner surface of the windshield of the autonomous vehicle. Some of the algorithms that are used to process the information picked up by the sensors use a known location of the sensor. The location that is used by the algorithms can be a certain point of reference in the host vehicle. For example, image processing algorithms can estimate a time to collision to a vehicle that is detected in images of an environment ahead of the vehicle based on a location of the camera that was used to capture the images in the host vehicle (the vehicle within which the camera is installed). Affixing the sensors to the windshield at a fixed location (e.g., at a certain distance from the edges of the windshield) is therefore desirable.

Debris from the road and/or from other vehicles travelling on the road can impact the windshield of a moving vehicle. Such impacts may cause cracking or severe damage to the windshield, requiring replacement of the windshield. A windshield may also require replacement due to other reasons such as, for example, damage to the edges of the windshield, or to other components attached to the windshield. To replace the windshield, a technician may need to remove any devices (e.g., cameras, sensors, etc.) attached to the inner surface of the windshield and reattach the devices to the replacement windshield. To minimize recalibration of the control system, the locations of the devices relative to edges of the replacement windshield should be maintained as close as possible to the locations of the devices relative to the edges of the original windshield. One way to do this may be to measure the positions of the devices on the original windshield before disassembling the devices from the windshield and reattaching the devices to the replacement windshield based on the measurements. Making accurate measurements during windshield replacement, however, may be difficult, time consuming, and prone to error.

The alignment tool of the present disclosure solves one or more of the problems set forth above and/or other problems in the art.

### SUMMARY

In one aspect, the present disclosure is directed to an alignment tool. The alignment tool may include a frame. The alignment tool may also include at least one connector attached to the frame. The at least one connector may be configured to releasably attach the frame to an outer surface of a windshield. The alignment tool may include at least one link member. The link member may be fixedly attached to the frame at one end. The link member may also include an edge connection member at an opposite end. The edge connection member may be configured to engage with at least one edge of the windshield. The at least one link member may also have an adjustable length. The at least one link member may be configured to releasably attach the frame to the at least one edge of the windshield.

In another aspect, the present disclosure is directed to a method of relocating a device. The method may include making a first mark on an outer surface of a windshield of a vehicle. The first mark may correspond to a position of a device attached to an inner surface of the windshield. The method may further include disassembling the windshield from the vehicle. The method may include positioning an alignment tool on the outer surface of the windshield at a first location corresponding to the first mark. Additionally, the method may include determining one or more first distances of the alignment tool relative to first edges of the windshield. The method may also include positioning the alignment tool at a second location on a replacement windshield such that one or more second distances of the alignment tool from second edges of the replacement windshield are about equal to the one or more first distances. Further, the method may include making a second mark on the replacement windshield. The second mark may correspond to the second location of the alignment tool. The method may include assembling the replacement windshield on the vehicle. In addition, the method may include attaching the device to the replacement windshield based on the second mark.

In another aspect, the present disclosure is directed to a method of relocating a camera. The method may include making a first mark on an outer surface of a windshield of a vehicle. The first mark may correspond to a position of a camera attached to an inner surface of the windshield. The method may further include disassembling the windshield from the vehicle. The method may include positioning an alignment tool on the outer surface of the windshield at a first location corresponding to the first mark. Additionally, the method may include determining one or more first distances of the alignment tool relative to first edges of the windshield. The method may also include positioning the alignment tool at a second location on a replacement windshield such that one or more second distances of the alignment tool from second edges of the replacement windshield are about equal to the one or more first distances. Further, the method may include making a second mark on the replacement windshield. The second mark may correspond to the second location of the alignment tool. The method may include assembling the replacement windshield on the vehicle. In addition, the method may include attaching the camera to the replacement windshield based on the second mark.

### BRIEF DESCRIPTION OF THE DRAWINGS

FIG. 1 is a diagrammatic side view representation of a vehicle consistent with the disclosed embodiments;

FIG. 2 is a diagrammatic representation of an interior of a vehicle consistent with disclosed embodiments;

FIG. 3 is a pictorial illustration of an alignment tool consistent with disclosed embodiments;

FIG. 4 is a pictorial illustration of a frame of the alignment tool of FIG. 3, consistent with disclosed embodiments;

FIG. 5 is a pictorial illustration of a link member of the alignment tool of FIG. 3, consistent with disclosed embodiments;

FIG. 6 is a pictorial illustration of a windshield after it has been disassembled from the vehicle of FIG. 1, consistent with disclosed embodiments;

FIG. 7 is pictorial illustration of an assembly of the alignment tool of FIG. 3 on a windshield, consistent with disclosed embodiments;

FIG. 8 is a pictorial illustration of an assembly of another alignment tool on a windshield, consistent with disclosed embodiments;

FIG. 9 is a pictorial illustration of another alignment tool on a windshield, consistent with disclosed embodiments;

FIG. 10 is a flow chart illustrating a method of replacing a windshield using the alignment tool of FIG. 3, consistent with disclosed embodiments;

FIG. 11A is a diagrammatic front view representation of a vehicle consistent with the disclosed embodiments;

FIG. 11B is a diagrammatic front view representation of an alignment tool assembled on a windshield of the vehicle of FIG. 11A, consistent with disclosed embodiments;

FIG. 11C is a diagrammatic representation of the windshield of the vehicle of FIG. 11A after disassembly from the vehicle of FIG. 11A, consistent with disclose embodiments;

FIG. 11D is a diagrammatic representation of the alignment tool of FIG. 3 partially attached to the windshield of FIG. 11C, consistent with the disclosed embodiments;

FIG. 11E is another diagrammatic representation of the alignment tool of FIG. 3 partially attached to the windshield of FIG. 11C, consistent with the disclosed embodiments;

FIG. 11F is a diagrammatic representation of the alignment tool of FIG. 3 fully attached to the windshield of FIG. 11C, consistent with the disclosed embodiments;

FIG. 11G is a diagrammatic representation of the alignment tool of FIG. 3 fully attached to a replacement windshield, consistent with the disclosed embodiments;

FIG. 11H is a diagrammatic representation of the replacement windshield of FIG. 11G after the alignment tool of FIG. 3 has been disassembled from the replacement windshield, consistent with the disclosed embodiments;

FIG. 12 is a flow chart illustrating a method of replacing a windshield using the alignment tool of FIG. 9, consistent with disclosed embodiments;

FIG. 13 is another flow chart illustrating a method of replacing a windshield using the alignment tool of FIG. 3, consistent with disclosed embodiments; and

FIG. 14 is a diagrammatic front view representation of an alignment tool assembled on a windshield of the vehicle of FIG. 11A, consistent with disclosed embodiments.

### DETAILED DESCRIPTION

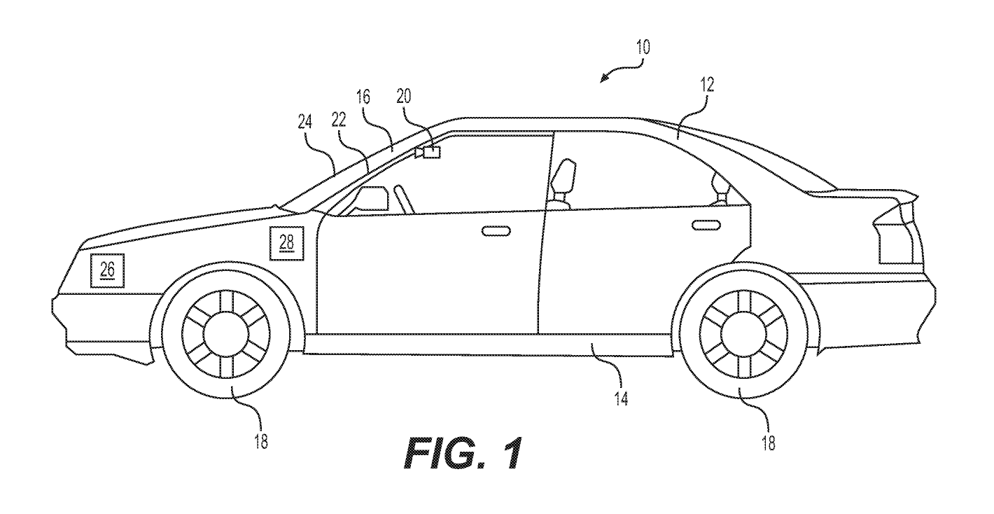

FIG. 1 illustrates an exemplary embodiment of a vehicle 10, including a body 12, a chassis 14, and a windshield 16. Chassis 14 may be supported by wheels 18, which may allow vehicle 10 to move in a forward or rearward direction. As illustrated in the exemplary embodiment of FIG. 1, vehicle 10 may be an automobile. It is contemplated, however, that vehicle 10 may be any other type of land-based vehicle, an aircraft, a water-borne vehicle, or an amphibious vehicle configured to be driven manually or autonomously.

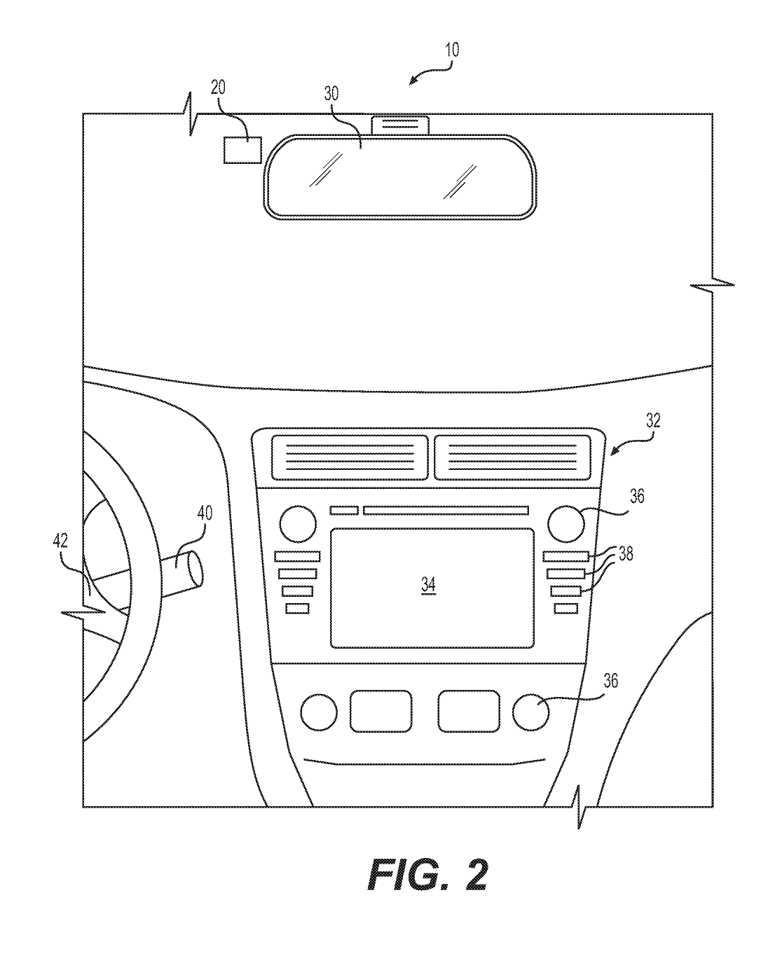

Windshield 16 of vehicle 10 may include an inner surface 22 and an outer surface 24. One or more devices 20 may be attached to inner surface 22 of windshield 16. Device 20 may be any type of device that generates visual or non-visual signals, data, and/or information. For example, as illustrated in FIG. 1, device 20 may be an image capture device or camera, which may be configured to capture an image of the road in front of the vehicle. It is contemplated, however, that device 20 may be a sensor configured to generate data regarding a position or speed of the vehicle, or a distance of the vehicle from other objects, etc. Device 20 may also include satellite or radio antennae, or one or more sensors such as, for example, temperature sensors, rain sensors, light sensors, global positioning sensors, or any other type of sensors that may be required for operation of vehicle 10. The one or more sensors of device 20 may also be optical sensors, acoustic sensors, electromagnetic sensors, infrared sensors, or any other type of sensors known in the art. In some exemplary embodiments, the one or more sensors of device 20 may be integrated with a rear-view mirror 30 (see FIG. 2).

Vehicle 10 may include a power source 26 and a control system 28. Power source 26 may be an engine, which may generate a power output that can be directed through wheels 18 to propel vehicle 10 in a forward or rearward direction. For example, power source 26 may be any suitable type of internal combustion engine, such as a gasoline, diesel, natural gas, or hybrid-powered engine. It is contemplated, however, that power source 26 may be driven by electricity. For example, power source 26 may be an electric motor driven by electrical power supplied by one or more batteries (not shown). Additionally or alternatively, power source 26 may be configured to deliver power output to a generator (not shown), which may in turn drive one or more electric motors (not shown) coupled to wheels 18. Control system 28 may receive signals from devices 20, power source 26, and/or other components of vehicle 10. Control system 28 may also generate signals to control power source 26, and/or other components of vehicle 10, during operation of vehicle 10.

FIG. 2 shows an exemplary representation of an interior of vehicle 10. As illustrated in FIG. 2, vehicle 10 may include a rear-view mirror 30 and a user interface 32. User interface 32 may include a touch screen 34, knobs 36, buttons 38, etc. Vehicle 10 may also include handles 40 (e.g. located on or near steering column 42 including, for example, turn signal handles) to interact with vehicle 10. As illustrated in the exemplary embodiment of FIG. 2, one or more devices 20 may be attached to inner surface 22 of windshield 16. In case two or more devices 20 are attached to inner surface 22 of windshield 16, the two or more devices 20 can be adjacent to one another, or even seamlessly attached, forming a single block, or the two or more devices can be physically removed from one another and located at different locations on the inner surface 22 of the windshield 16.

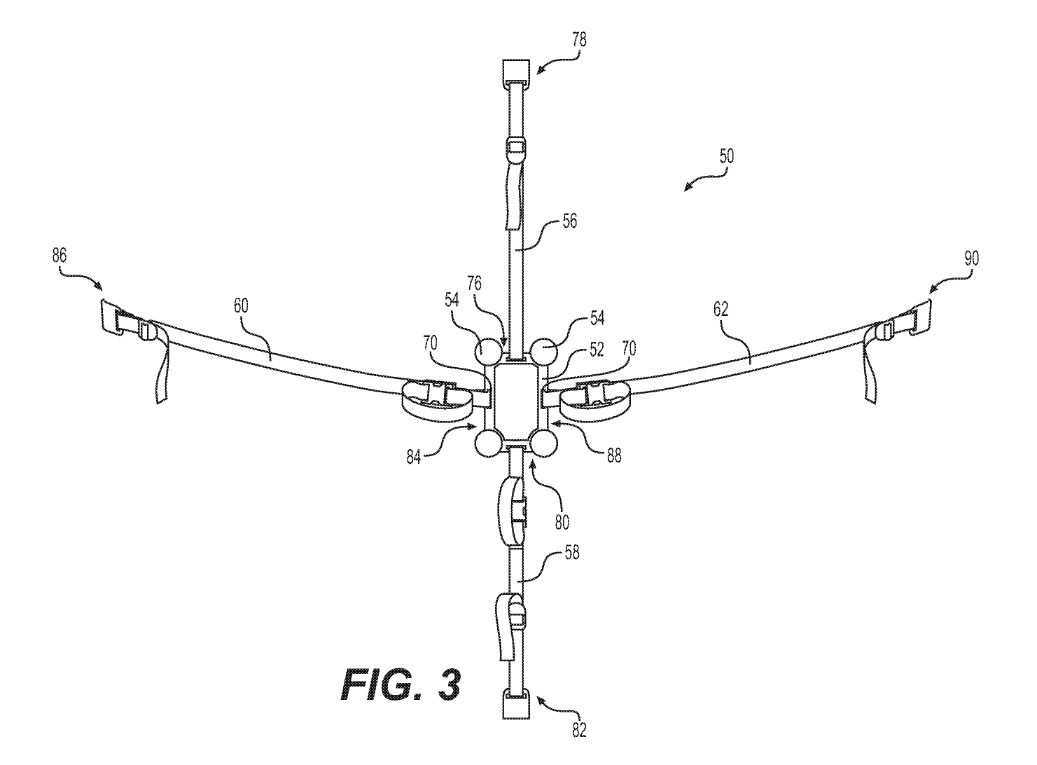

FIG. 3 shows an exemplary embodiment of an alignment tool 50, which may be used to determine a position at which device 20 may be attached to windshield 16. Alignment tool 50 may include frame 52, connectors 54, and one or more of link members 56, 58, 60, 62. Although four link members 56, 58, 60, 62 have been illustrated in FIG. 3, it is contemplated that frame 52 may have any number of link members. In one exemplary embodiment, frame 52 may have at least three link members 56, 58, 60.

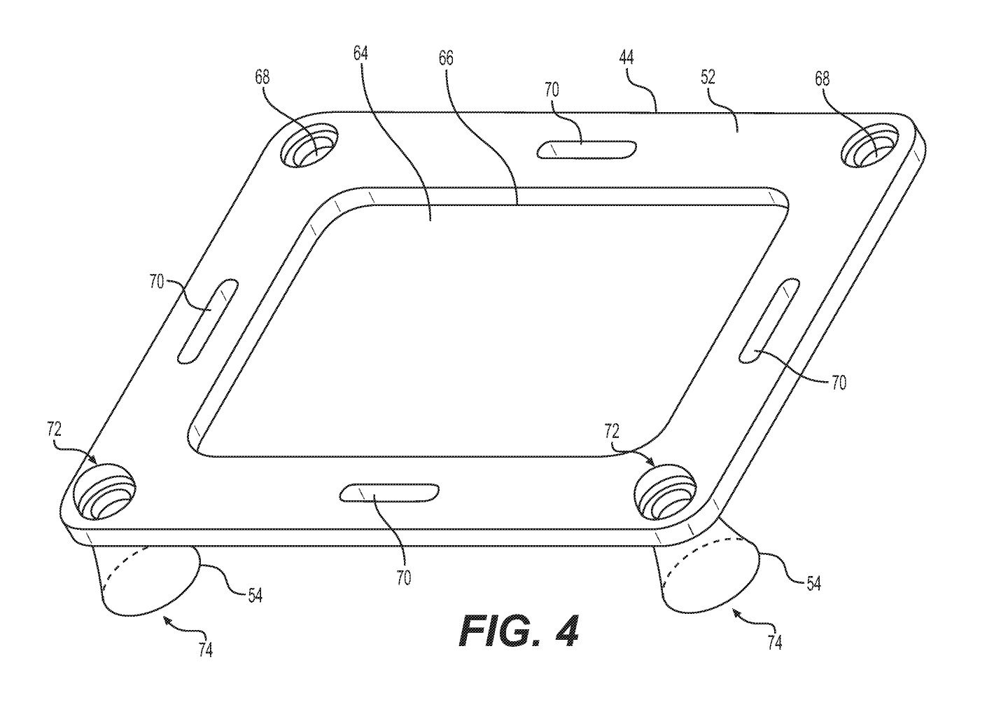

FIG. 4 illustrates an exemplary embodiment of frame 52. As illustrated in FIG. 4, frame 52 may be generally planar and annular with an opening 64 through a thickness of frame 52. Frame 52 may have an outer perimeter 44. One or both of frame 52 and opening 64 may have a rectangular shape, a square shape, a triangular shape, a polygonal shape, a circular shape, or an elliptical shape. It is contemplated that frame 52 and opening 64 may have any other geometrical shape known in the art. In one exemplary embodiment, an inner perimeter 66 of opening 64 may have a shape that matches or generally matches (i.e., has the same shape and dimensions) as a perimeter over which device 20 may be attached to inner surface 22 of windshield 16. It is also contemplated that in some exemplary embodiments, inner perimeter 66 of opening 64 may have a shape that matches or generally matches (i.e., has the same shape and dimensions) a perimeter of an extension, or another feature of device 20. For example, inner perimeter 66 may have a shape that matches or generally matches a perimeter of a lens, a viewfinder, a handle, a button, a knob, etc., associated with device 20.

In one exemplary embodiment as illustrated in FIG. 4, frame 52 may include one or more holes 68 and one or more slots 70. Holes 68 may be disposed adjacent the four corners of frame 52. It is contemplated, however, that holes 68 may be disposed anywhere on frame 52. Holes 68 may be round or generally round, but other shapes are also contemplated. Holes 68 may be configured to receive connectors 54. As also illustrated in FIG. 4, slots 70 may be disposed along edges of frame 52. It is contemplated, however, that like holes 68, slots 70 may be disposed anywhere on frame 52. In one exemplary embodiment as illustrated in FIG. 4, slot 70 may have a rectangular or generally rectangular shape with rounded ends. It is contemplated, however, that slot 70 may have a rectangular shape, a square shape, a polygonal shape, a triangular shape, a circular shape, an elliptical shape, or any other geometrical shape known in the art. Slots 70 may be configured to receive link members 56, 58, 60, 62. Although four holes 68 and four slots 70 have been illustrated in FIG. 4, it is contemplated that frame 52 may have any number of holes 68 and slots 70. In one exemplary embodiment, a number of slots 70 may be equal to a number of link members 56, 58, 60, and/or 62 attached to frame 52. In another exemplary embodiment, frame 52 may have at least three holes 68 and three slots 70.

Connector 54 may have a first end 72 connected to frame 52 and a second end 74 configured to be releasably attached to outer surface 24 of windshield 16. In one exemplary embodiment as illustrated in FIG. 4, connector 54 may be a suction cup. It is contemplated, however, that connector 54 may be any other type of connector known in the art for releasably attaching frame 52 to windshield 16. Connector 54 may be configured to dispose frame 52 at a predetermined distance from outer surface 24 of windshield 16.

Returning to FIG. 3, first link member 56 may extend from first end 76 to second end 78. Second link member 58 may extend from first end 80 to second end 82. Third link member 60 may extend from first end 84 to second end 86. Fourth link member 62 may extend from first end 88 to second end 90. First ends 76, 80, 84, 88 of first, second, third, and fourth link members 56, 58, 60, 62, respectively, may be fixedly attached to frame 52. In one exemplary embodiment as illustrated in FIG. 3, first ends 76, 80, 84, 88 of first, second, third, and fourth link members 56, 58, 60, 62, respectively, may pass through slots 70 of frame 52, forming closed loops to attach first ends 76, 80, 84, 88 to slots 70. It is contemplated, however, that first ends 76, 80, 84, 88 of first, second, third, and fourth link members 56, 58, 60, 62, respectively, may be attached to frame 52, using adhesives, fasteners, rivets, or by any other method known in the art.

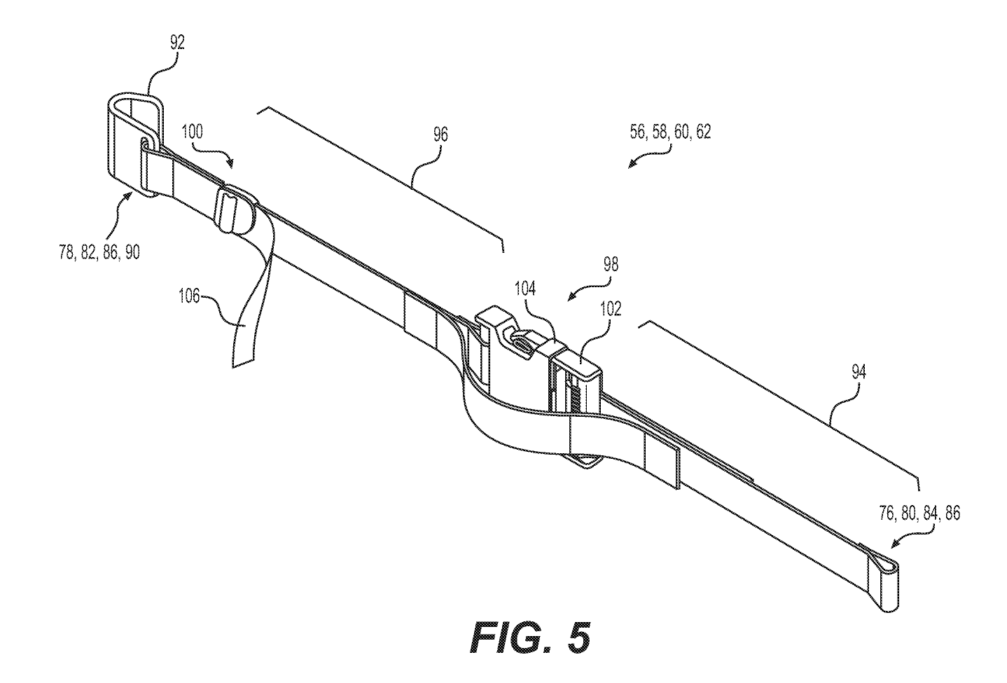

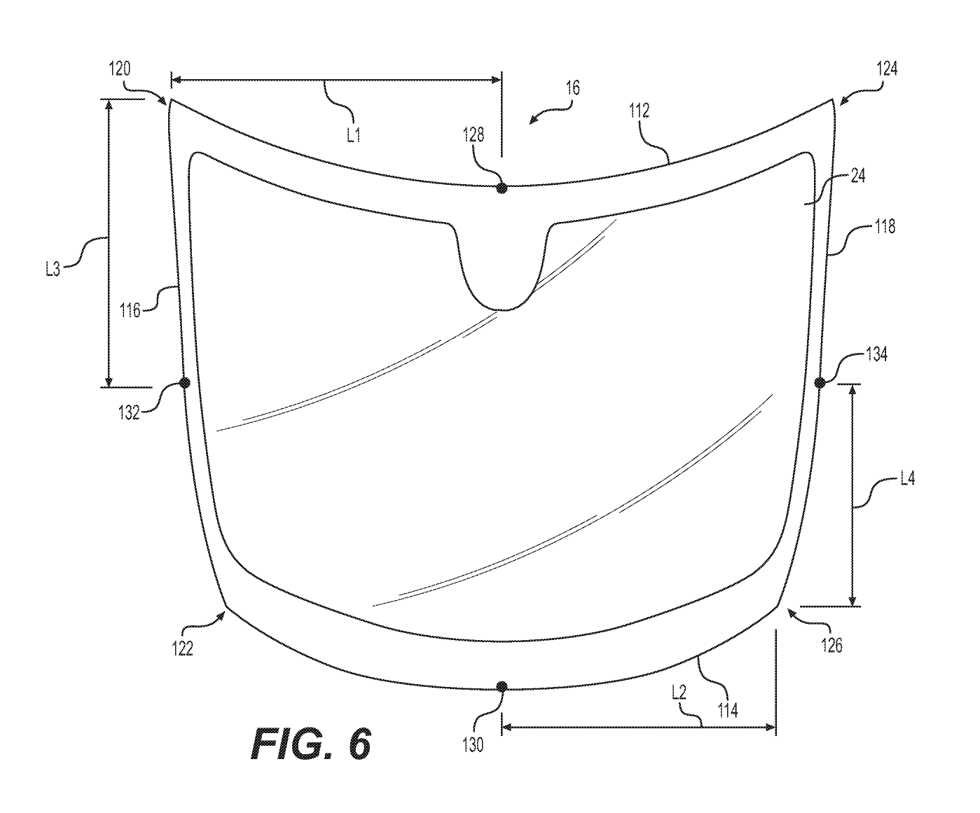

FIG. 5 illustrates an exemplary embodiment of link members 56, 58, 60, 62. The following description of FIG. 5 relates to link member 56 but it is equally applicable to link members 58, 60, and 62, which may have a structure and function similar to that of link member 56. As illustrated in FIG. 6, link member 56 may include edge connection member 92, for example, hook 92 attached to second end 78. It is contemplated that any other type of clip or releasable connector known in the art may be attached to second end 78 instead of hook 92. In one example, such a clip or releasable connector is configured to latch, clasp or otherwise connect to an edge or to a lip at the edge of the windshield. Link member 56 may have an inner section 94, outer section 96, coupler 98, and length adjuster 100. Inner section 94 may extend from first end 76 to coupler 98. Outer section 96 may extend from coupler 98 to hook 92. Coupler 98 may have clip 102 and clip receiver 104. Clip 102 may be attached to inner section 94 and clip receiver 104 may be attached to outer section 96. Clip receiver 104 of coupler 98 may be configured to receive clip 102, which may be insertable into clip receiver 104 to attach clip 102 to clip receiver 104. Attaching clip 102 to clip receiver 104 may connect inner section 94 with outer section 96. Clip 102 and clip receiver 104 may form a quick-disconnect coupling, which may allow inner section 94 to be quickly and easily disconnected from outer section 96.

In one exemplary embodiment as illustrated in FIG. 5, link member 56 may be a strap in which inner section 94 may have a fixed length, whereas a length of outer section 96 may be adjustable. For example, pulling on free end 106 of link member 56 may allow a length of outer section 96 to be reduced. It is contemplated, however, that either or both of inner section 94 and outer section 96 may include length adjusters 100. It is also contemplated that in some exemplary embodiments, length adjuster 100 may be combined with coupler 98 and/or hook 92 to allow adjustment of the strap length. In one exemplary embodiment, both inner and outer sections 94, 96 of link member 56 may have a fixed length, while at least one of inner and outer sections 94, 96 of one or more of link members 58, 60, and 62 may have an adjustable length. Although FIG. 5 illustrates link member 56 in the form of a strap, it is contemplated that link members 56, 58, 60, 62 may instead include telescoping structural members that may allow a length of link members 56, 58, 60, 62 to be adjusted. It is also contemplated that link members 56, 58, 60, 62 may have any other structural configuration known in the art (sliding, rack and pinion, etc.) that may allow a length of one or more of link members 56, 58, 60, 62 to be adjusted. It is also contemplated that link members 56, 58, 60, 62 may have quick disconnect hooks 92 instead of or in addition to quick disconnect couplers 98.

FIG. 6 illustrates windshield 16, which may be disassembled from vehicle 10. Windshield 16 may have a first edge 112 and a second edge 114 disposed opposite first edge 112. Windshield 16 may also have a third edge 116, which may extend between first edge 112 and second edge 114. In addition, windshield 16 may have a fourth edge 118, extending between first edge 112 and second edge 114. Fourth edge 118 may be disposed opposite third edge 116. Third edge 116 may intersect with first edge 112 and second edge 114 at first corner 120 and second corner 122, respectively. Likewise, fourth edge 118 may intersect with first edge 112 and second edge 114 at third corner 124 and fourth corner 126, respectively. As illustrated in the exemplary embodiment of FIG. 6, one or more of first, second, third, and fourth edges 112, 114, 116, 118, may have a curvilinear shape. One or more of first, second, third, and fourth corners 120, 122, 124, 126 may also have a rounded shape. In one exemplary embodiment, windshield 16 may include a first set of positions including first position 128, second position 130, third position 132, and fourth position 134. As illustrated in FIG. 6, first, second, third, and fourth positions may be positions on first, second, third, and fourth edges 112, 114, 116, 118, respectively. In one exemplary embodiment first position 128 may be located at distance L₁ from corner 120, second position 130 may be located at distance L₂ from corner 126, third position 132 may be located at distance L₃ from corner 120, and fourth position 134 may be located at distance L₄ from corner 126. It is contemplated, however, that distances L₁, L₂, L₃, L₄ of first, second, third, and fourth positions 128, 130, 132, 134, respectively, may be determined from any of first, second, third, and fourth corners 120, 122, 124, 126 of windshield 16.

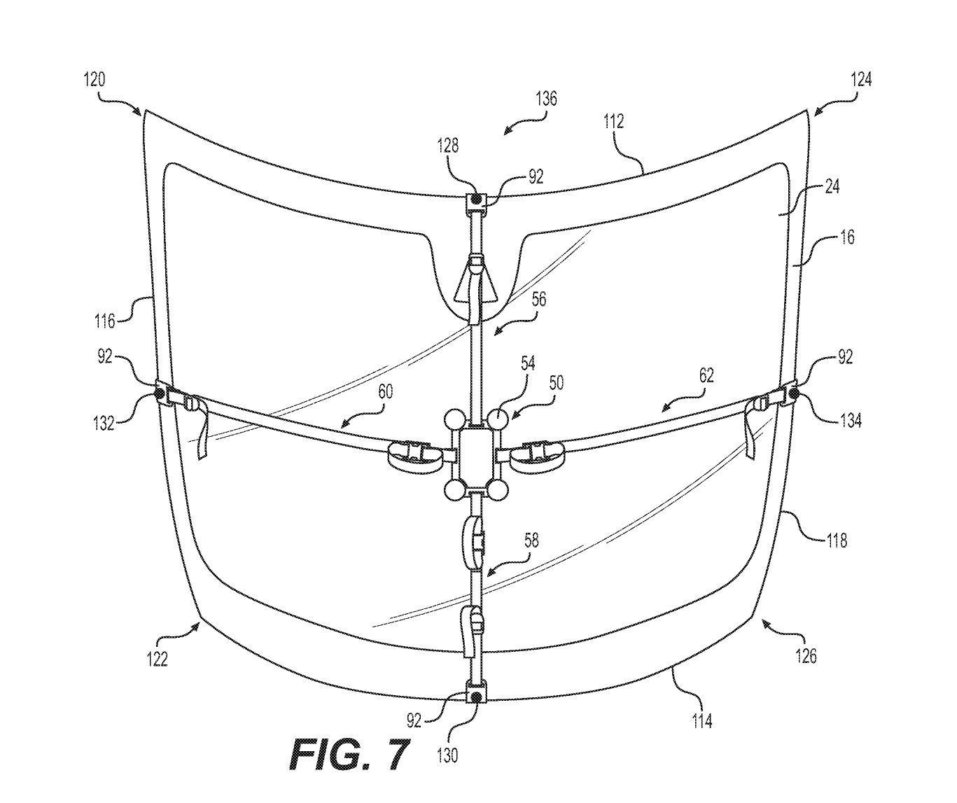

FIG. 7 illustrates an exemplary assembly 136 of alignment tool 50 and windshield 16. Alignment tool 50 may be attached to outer surface 24 of windshield 16 via connectors 54. For example, as illustrated in FIG. 7, connectors 54 may engage with outer surface 24 of windshield 16 to attach frame 52 of alignment tool 50 to windshield 16. Hook 92 of first link member 56 may engage with first edge 112 of windshield 16 at first position 128. Hook 92 of second link member 58 may engage with second edge 114 of windshield 16 at second position 130. Hook 92 of third link member 60 may engage with third edge 116 of windshield 16 at third position 132. Hook 92 of fourth link member 62 may engage with fourth edge 118 of windshield 16 at fourth position 134. As also illustrated in FIG. 6, lengths of first, second, third, and fourth link members 56, 58, 60, 62 may be adjusted so that each of link members 56, 58, 60, 62 is disposed without any slack. Each of link members 56, 58, 60, and 62 may be determined to be without any slack when pulling on free end 106 does not reduce a length of inner or outer sections 94, 96 of the respective one of link members 56, 58, 60, 62. Although FIG. 7 illustrates hook 92 of only one link member 56, 58, 60, or 62 attached to each of first, second, third, and fourth edges 112, 114, 116, 118, it is contemplated that more than one of link members 56, 58, 60, 62 may be attached to a same edge 112, 114, 116, or 118 of windshield 16.

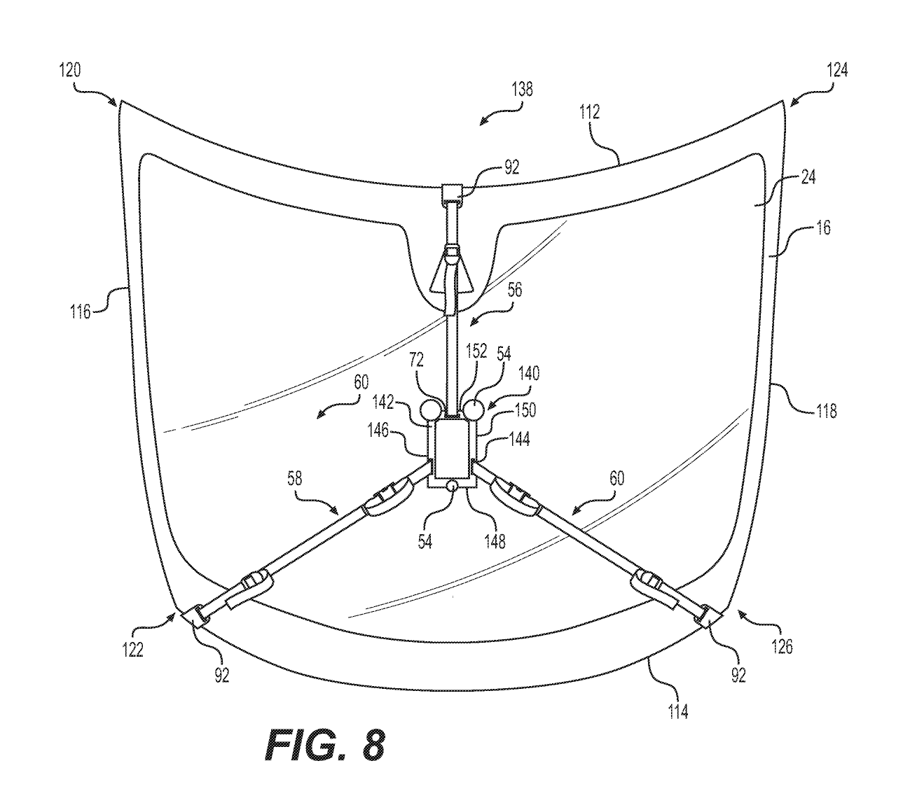

FIG. 8 illustrates an assembly 138, including alignment tool 140 that may have only three link members 56, 58, and 60. Alignment tool 140 may have a frame 142 with many of the features similar to those described above with respect to frame 52. In one exemplary embodiment, slots 144 of alignment tool 140 may be inclined relative to one or more of the outer edges 146, 148, 150, and/or 152 of frame 142 of alignment tool 140. First link member 56 of alignment tool 140 may be attached to first edge 112 of windshield 16. Second and third link members 58 and 60 of alignment tool 140 may be attached to second edge 114 of windshield 16. It is contemplated, however, that first, second, and third link members 56, 58, and 60 of alignment tool 140 may alternatively be attached to any three of first, second, third, and fourth edges 112, 114, 116, 118 of windshield 16.

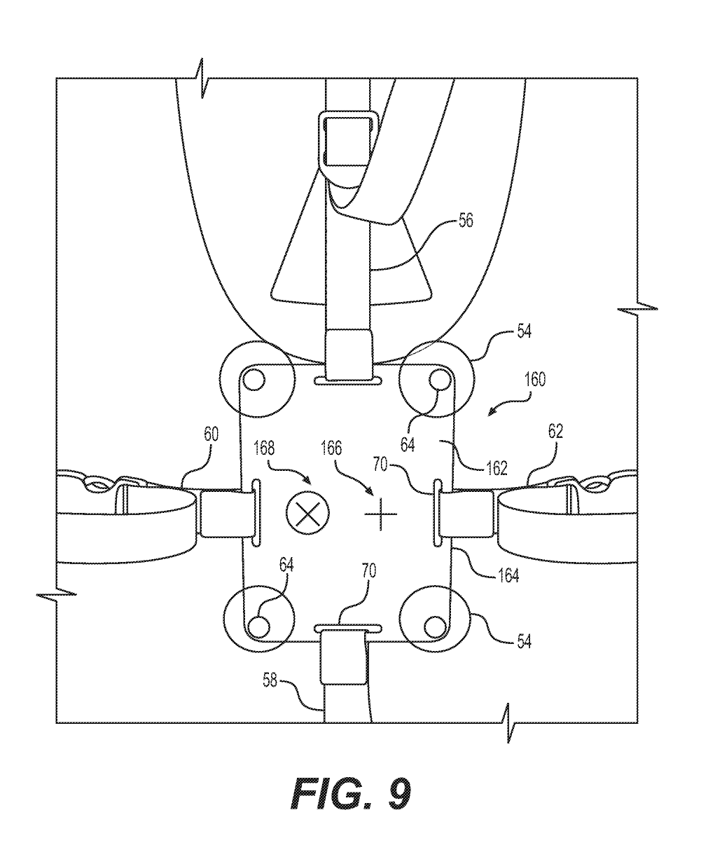

FIG. 9 shows another exemplary embodiment of an alignment tool 160, which may be used to determine a position at which device 20 may be attached to windshield 16. Alignment tool 160 may include plate 162, connectors 54, and one or more of link members 56, 58, 60, 62. Although four link members 56, 58, 60, 62 have been illustrated in FIG. 8, it is contemplated that alignment tool 160 may have any number of link members. In one exemplary embodiment, alignment tool 160 may have at least three link members 56, 58, 60. It is also contemplated that one or more of link members 56, 58, 60, 62 may be attached to one or more of edges 112, 114, 116, and/or 118 of windshield 16. Plate 162 may be generally planar having a predetermined thickness and outer perimeter 164. Plate 162 may have a rectangular shape, a square shape, a triangular shape, a polygonal shape, a circular shape, or an elliptical shape. It is contemplated that plate 162 may have any other geometrical shape known in the art. Plate 162 may include one or more openings 64 and one or more slots 70 similar to that of frames 52 and 142. Plate 162 may also include one or more fiducial marks 166, 168. The shapes and dimensions of the one or more fiducial marks 166, 168 may be similar to shapes and dimensions of fiducial marks that may be present on device 20. For example, as shown in the exemplary embodiment of FIG. 8, fiducial mark 166 may be in the form of a plus sign “+” and fiducial mark 168 may be in the form of an “x” within a circle (e.g., \textcircled{x}).

The disclosed alignment tools may be implemented for replacing windshields on any vehicle in which one or more devices may be attached to an inside surface of a windshield of the vehicle. In particular, the alignment tools of the present disclosure may be used to transfer a device attached to a windshield to a generally identical location on a replacement windshield without the need for precise measurements during the replacement operations. Any replacement windshield that is appropriate in size and/or shape for the vehicle is contemplated and consistent with the disclosed embodiments. Exemplary methods of replacing a windshield using the disclosed alignment tools are described below.

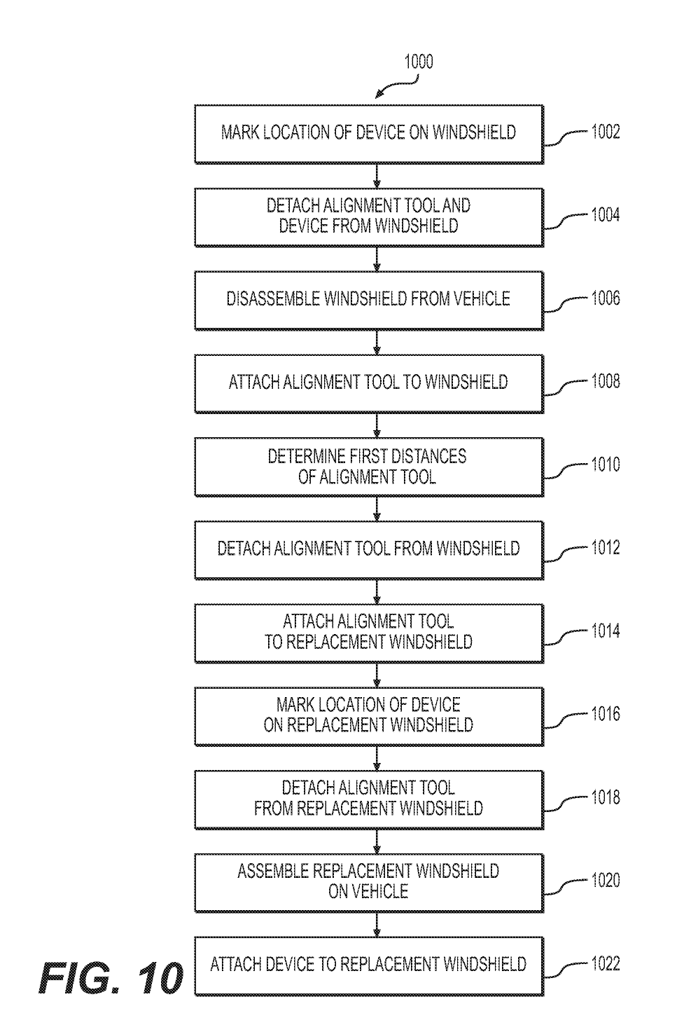

FIG. 10 illustrates an exemplary method 1000 of replacing windshield 16 having device 20 attached to inner surface 22 with a replacement windshield 170, using alignment tool 50. The order and arrangement of steps in method 1000 is provided for purposes of illustration. As will be appreciated from this disclosure, modifications may be made to method 1000 by, for example, adding, combining, removing, and/or rearranging the steps of method 1000.

Method 1000 may include a step of marking a location of device 20 on windshield 16 (Step 1002). Marking the location may include positioning alignment tool 50 on outer surface 24 of windshield 16 so that inner perimeter 66 of opening 64 may overlap or generally overlap with a perimeter 172 of device 20 attached to inner surface 22 of windshield 16. As used in this disclosure, the phrase generally overlap suggests that a distance (i.e. separation), on a surface parallel or generally parallel to outer surface 24 of windshield 16, between inner perimeter 66 and perimeter 172 of device may, for example, be less than a threshold amount. In one exemplary embodiment, the threshold amount may be a fraction of a millimeter (e.g. ±0.1 mm or ±0.5 mm) or a fraction of an inch. It is contemplated that an operator may determine whether inner perimeter 66 overlaps perimeter 172 of the device based on visual observations. As used in this disclosure the phrase “generally parallel” suggests that the two surfaces may be inclined relative to each other at an angle less than about ±0.5°.

Marking the location may include firmly attaching frame 52 of alignment tool 50 to outer surface 24 of windshield 16 using connectors 54. In one exemplary embodiment, frame 52 may be attached to outer surface 24 using suction cups. Marking the location may further include marking an outline of inner perimeter 66 on outer surface 24 of windshield 16. In one exemplary embodiment, a writing instrument (e.g., marker or sharpie) may be traversed along inner perimeter 66 of frame 52 to draw outline 174 of inner perimeter 66 on outer surface 24 of windshield 16. In another exemplary embodiment the writing instrument may be traversed along outer perimeter 44 of frame 52 to draw an outline (not shown) of outer perimeter 44 on outer surface 24 of windshield 16. In yet another exemplary embodiment, frame 52 may have channels or gaps that generally match with portions of a perimeter 172 of device 20 and marking the location may include traversing the writing instrument within the channels in frame 52 to mark portions of perimeter 172 on outer surface 24 of windshield 16.

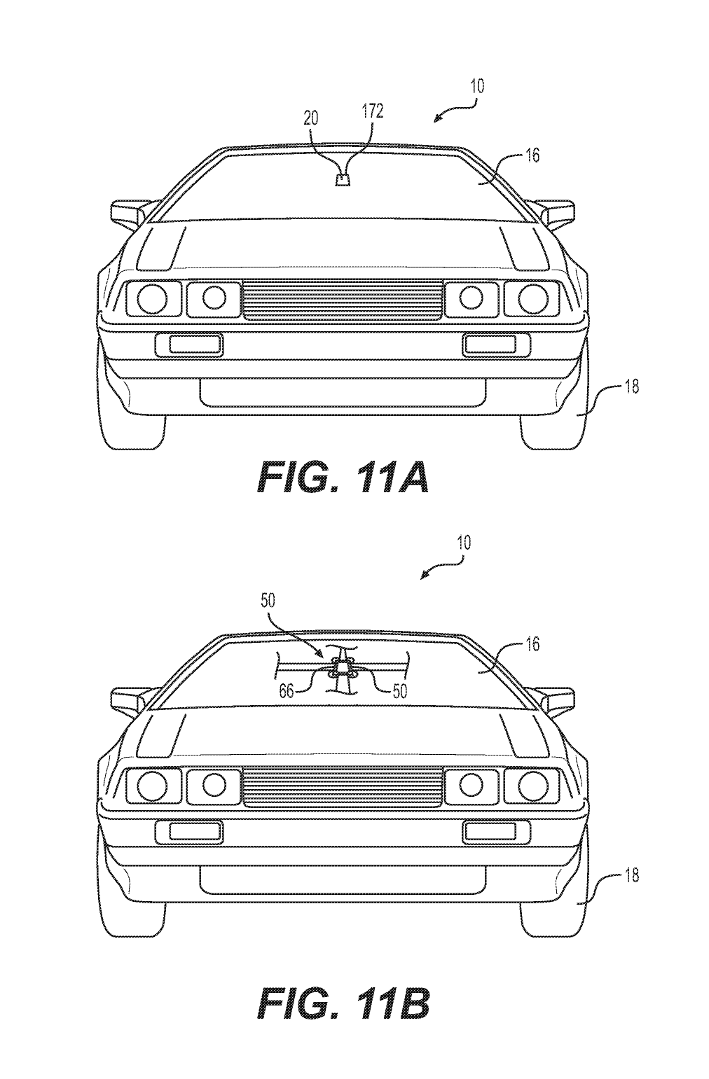

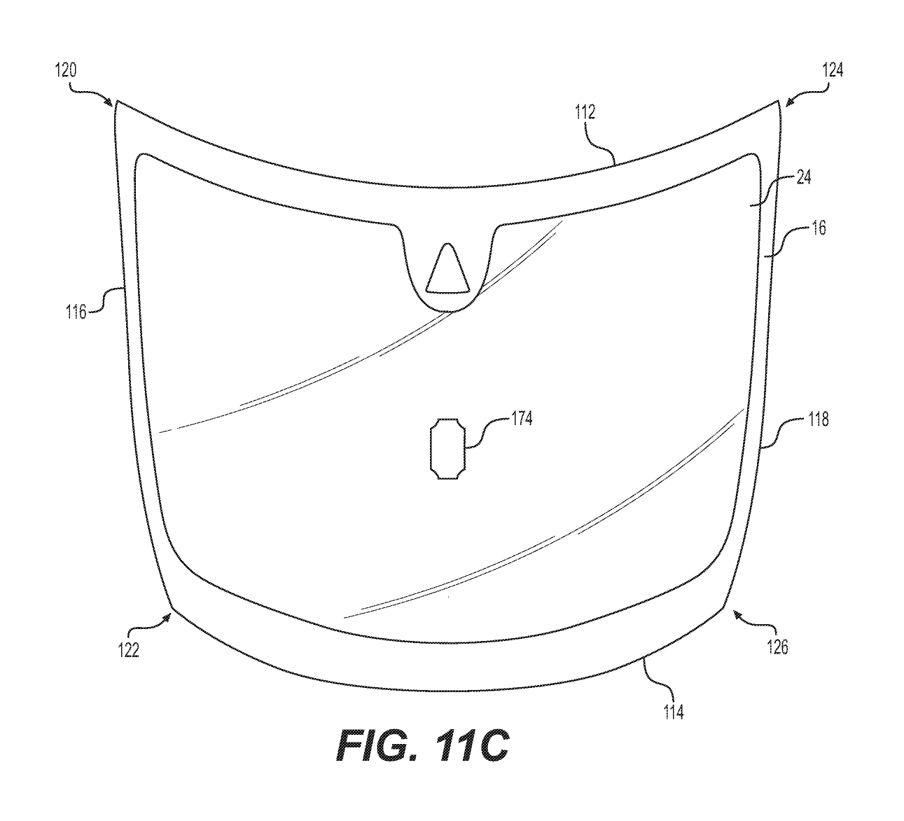

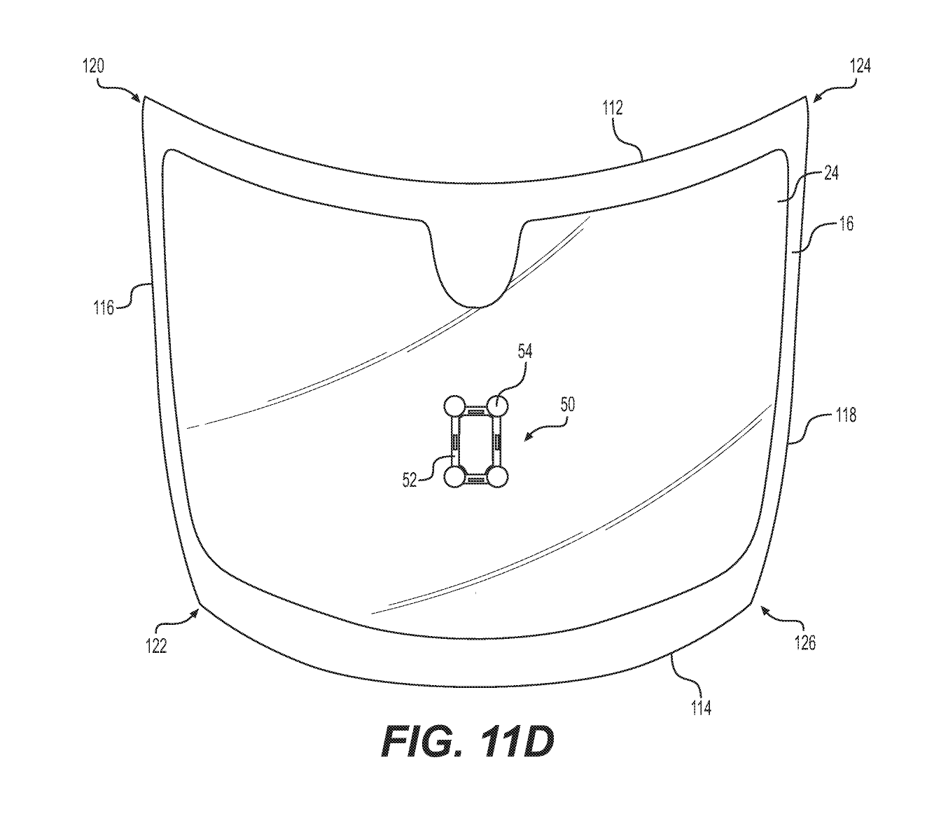

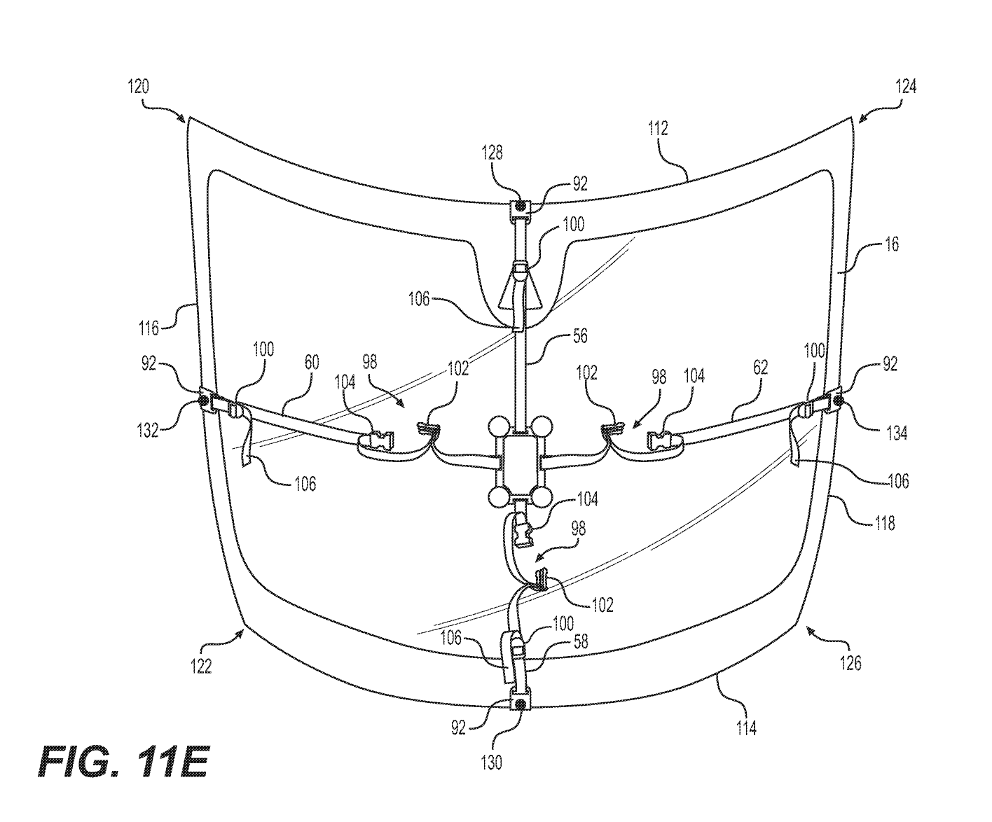

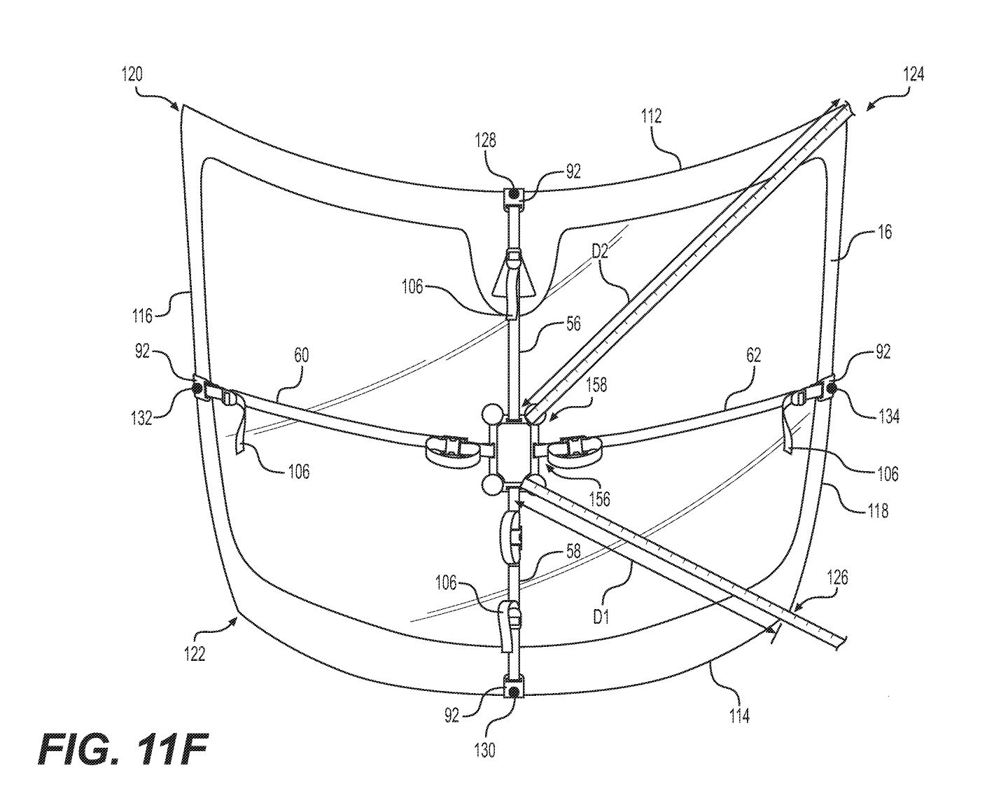

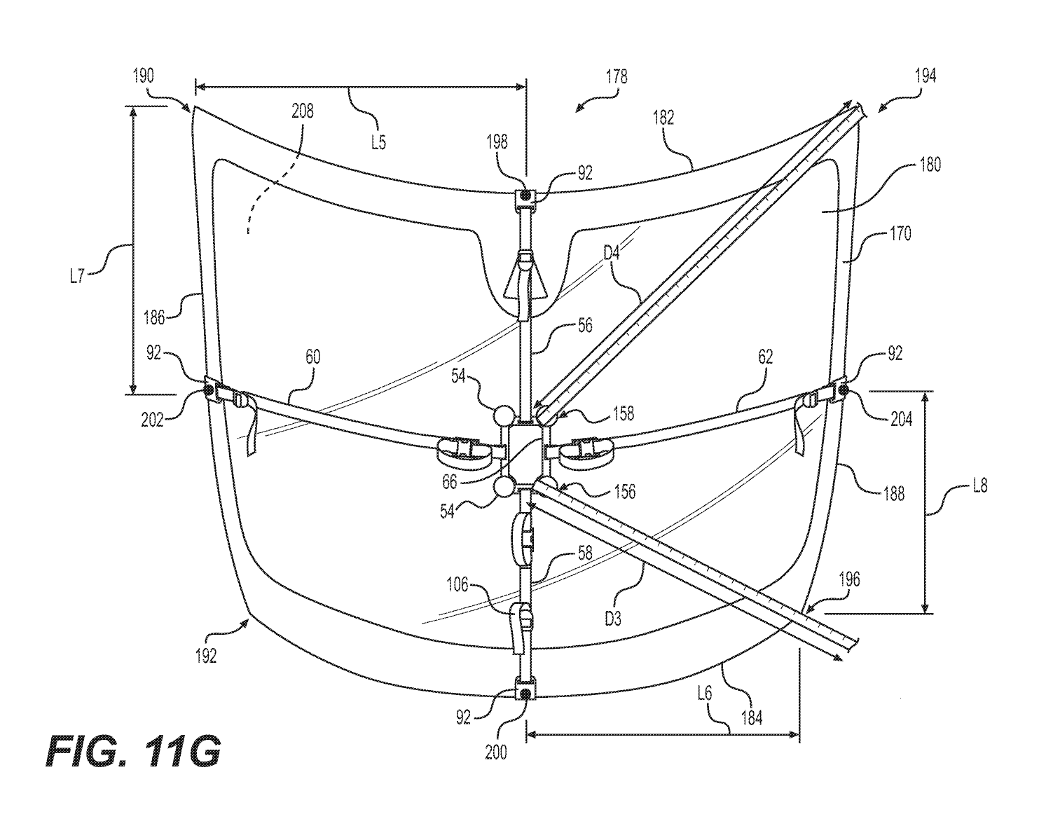

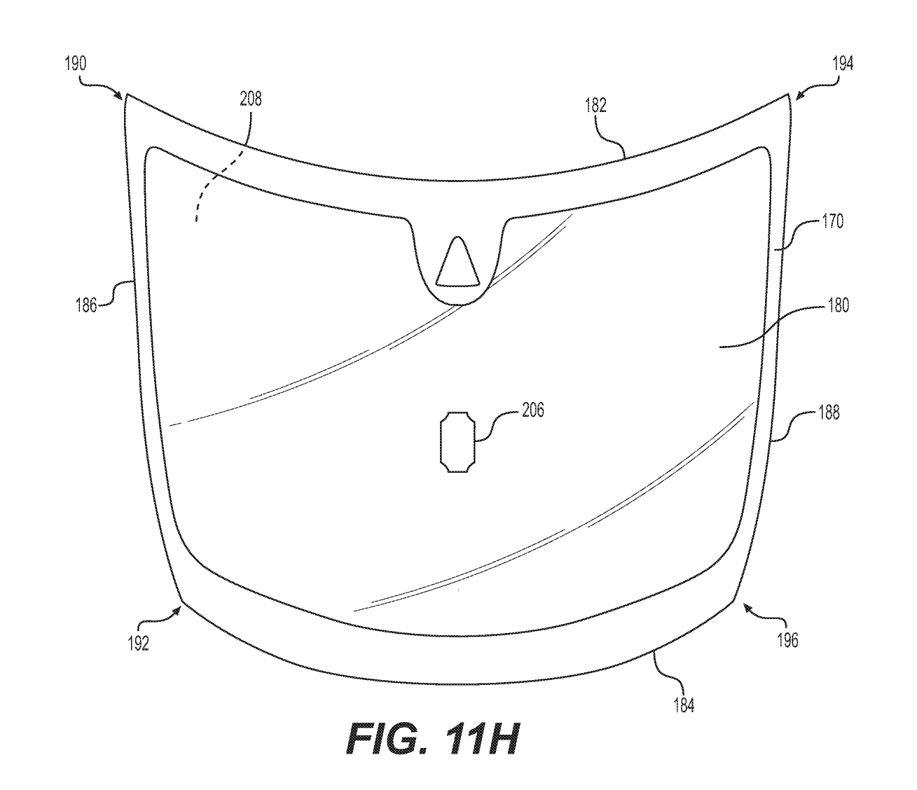

FIG. 11A illustrates an exemplary representation of vehicle 10 with device 20 attached to inner surface 22 of windshield 16. As illustrated in FIG. 11A, perimeter 172 of device 20 may be visible through windshield 16. FIG. 11B illustrates an exemplary representation of alignment tool 50 positioned on windshield 16 for marking the location of device 20. As illustrated in FIG. 11B, inner perimeter 66 of frame 52 of alignment tool 50 may generally overlap perimeter 172 of device 20. Both device 20 and alignment tool 50 have been shown magnified in FIGS. 11A and 11B for clarity.

Returning to method 1000, method 1000 may include a step of detaching alignment tool 50 and device 20 from windshield 16 (Step 1004). Detaching alignment tool 50 may include releasing connectors 54 from outer surface 24 of windshield 16. Device 20 may also be detached from inner surface 22 of windshield 16 according to instructions provided, for example, by a manufacturer of device 20. It is contemplated that when there may be more than one device 20 attached to windshield 16, steps 1002 and 1004 may have to be performed multiple times, using a separate alignment tool 50 for each device 20. In this exemplary scenario, multiple outlines 174 may be marked on outer surface 24 of windshield 16, each of the outlines 174 representing a perimeter 172 of a corresponding device 20.

Method 1000 may include a step of disassembling windshield 16 from vehicle 10 (Step 1006). FIG. 11C illustrates an exemplary representation of windshield 16 after it has been disassembled from vehicle 10. As illustrated in FIG. 11C, outer surface 24 of windshield 16 may have outline 174 of device 20. Method 1000 may include a step of attaching alignment tool 50 to windshield 16 (Step 1008) after windshield 16 has been disassembled from vehicle 10. Attaching alignment tool 50 may include positioning frame 52 such that inner perimeter 66 of opening 64 generally overlaps outline 174 on outer surface 24 of windshield 16. Attaching alignment tool 50 may further include firmly attaching connectors 54 (e.g., suction cups) to outer surface 24 of windshield 16. FIG. 11D illustrates an exemplary representation of windshield 16 after it has been disassembled from vehicle 10 and after alignment tool 50 has been attached to windshield 16. In FIG. 11D, link members 56, 58, 60, 62 have been omitted for clarity.

Method 1000 may include a step of determining first distances of alignment tool 50 relative to one or more edges 112, 114, 116, 118, corners 120, 122, 124, 126, and/or positions 128, 130, 132, 134 of windshield 16 (Step 1010). Determining first distances may include attaching hook 92 of first link member 56 to first edge 112 at first position 128, attaching hook 92 of second link member 58 to second edge 114 at second position 130, attaching hook 92 of third link member 60 to third edge 116 at third position 132, and attaching hook 92 of fourth link member 62 to fourth edge 118 at fourth position 134.

FIG. 11E illustrates an exemplary representation of windshield 16 after hooks 92 of first, second, third, and fourth link members 56, 58, 60, 62 have been attached to first, second, third, and fourth edges 112, 114, 116, 118, respectively, of windshield 16. Determining first distances may include inserting clip 102 into clip receiver 104 of quick disconnect couplers 98 of one or more of first, second, third, and fourth link members 56, 58, 60, and 62. Determining first distances may also include pulling on free ends 106 of one or more of first, second, third, and fourth link members 56, 58, 60, and 62 so that first, second, third, and fourth link members 56, 58, 60, and 62 are taut (i.e. fully extended with no loose portions) and have no slack. FIG. 11F illustrates an exemplary representation of windshield 16 after the one or more couplers have been engaged and the lengths of first, second, third, and fourth link members 56, 58, 60, and 62 have been adjusted.

Determining first distances may also include determining a distance of alignment tool 50 from one or more of edges 112, 114, 116, 118, one or more of corners 120, 122, 124, 126, and/or one or more of first, second, third, and fourth positions 128, 130, 132, 134. In one exemplary embodiment, as illustrated in FIG. 11F, a first reference distance “D₁” may be measured between corner 156 of alignment tool 50 and corner 126 of windshield 16. As also illustrated in FIG. 11F, a second reference distance “D₂” may be measured between corner 158 of alignment tool 50 and corner 124 of windshield 16. Although the dimensions D₁ and D₂ have been described relative to corners 156 and 158 of frame 52, it is contemplated that these dimensions may be measured between any of the one or more corners of frame 52 and any of the one or more corners 120, 122, 124, 126 of windshield 16. It is also contemplated that any number of such dimensional measurements may be made between locations on frame 52 and locations on windshield 16. As illustrated in FIG. 11F measurements D₁ and D₂ may be made using, for example, a tape measure. Other measurement methods including, for example, digital instruments, etc., are also contemplated and consistent with the disclosed embodiments.

Method 1000 may include a step of detaching alignment tool 50 from windshield 16 (Step 1012). Detaching alignment tool 50 may include disconnecting quick disconnect couplers 98, detaching hooks 92 from first, second, third, and fourth edges 112, 114, 116, 118 of windshield 16, and releasing connectors 54 from outer surface 24 of windshield 16, without changing the lengths of inner sections 94 and/or outer sections 96 of first, second, third, and fourth link members 56, 58, 60, and 62. It is contemplated that when there may be more than one device 20 attached to windshield 16, steps 1008 through 1012 may have to be performed multiple times, using a separate alignment tool 50 for each device 20. In this exemplary scenario, first distances may be separately determined using the separate alignment tools 50 for each of the plurality of devices 20 attached to windshield 16.

Method 1000 may include a step of attaching alignment tool 50 to replacement windshield 170 (Step 1014). FIG. 11G illustrates an exemplary assembly 178 of alignment tool 50 with replacement windshield 170. Replacement windshield 170 may have an outer surface 180. Replacement windshield 170 may also include a first edge 182 and a second edge 184 disposed opposite first edge 182. Replacement windshield 170 may also have a third edge 186, which may extend between first edge 182 and second edge 184. In addition, replacement windshield 170 may have a fourth edge 188, extending between first edge 182 and second edge 184. Fourth edge 188 may be disposed opposite third edge 186. Third edge 186 may intersect with first edge 182 and second edge 184 at first corner 190 and second corner 192, respectively. Likewise, fourth edge 188 may intersect with first edge 182 and second edge 184 at third corner 194 and fourth corner 196.

Attaching alignment tool 50 to replacement windshield 170 may include attaching hook 92 of first link member 56 to first edge 182, attaching hook 92 of second link member 58 to second edge 184, attaching hook 92 of third link member 60 to third edge 186, and attaching hook 92 of fourth link member 62 to fourth edge 188 of replacement windshield 170. Attaching alignment tool 50 to replacement windshield 170 may include determining a second set of positions for attaching hooks 92 of first, second, third, and fourth link members 56, 58, 60, 62 to first, second, third, and fourth edges 182, 184, 186, 188, respectively. Determining the second set of positions may include determining fifth position 198, sixth position 200, seventh position 202, and eighth position 204 on first, second, third, and fourth edges 182, 184, 186, 188, respectively such that distances of alignment tool 50 from one or more of corners 190, 192, 194, 196, one or more of edges 182, 184, 186, 188, and/or one or more of positions 198, 200, 202, 204 may be about equal to corresponding distances of alignment tool 50 from corresponding corners, edges, or positions on windshield 16.

For example, as illustrated in FIG. 11G, attaching alignment tool 50 to replacement windshield 170 may include determining distance L₅ between fifth position 198 and corner 190, distance L₆ between sixth position 200 and corner 196, distance L₇ between seventh position 202 and corner 190, and distance L₈ between eighth position 204 and corner 196. Attaching alignment tool 50 to replacement windshield 170 may further include adjusting positions of hooks 92 along one of more of edges 182, 184, 186, 188 so that distances L₅, L₆, L₇, and L₈ are equal or about equal to distances L₁, L₂, L₃, and L₄, respectively. As used in this disclosure, the phrase “about equal” indicates that two distances may differ by at most a least count measurement of the instrument being used to measure these distances. Thus, for example, two distances may be deemed to be about equal if they differ by not more than ±0.1 mm when measured with a tape measure that measures in millimeters and not more than ±⅛ th of an inch when measured with a tape measure that measures in inches.

In one exemplary embodiment, attaching alignment tool 50 to replacement windshield 170 may include adjusting a position of hooks 92 of first, second, third, and fourth link members 56, 58, 60, and 62 so that clips 102 may be insertable into clip receivers 104 of quick disconnect couplers 98 of one or more of first, second, third, and fourth link members 56, 58, 60, and 62. As illustrated in FIG. 11G, attaching alignment tool 50 to replacement windshield 170 may also include measuring a third reference distance “D₃” between corner 156 of alignment tool 50 and corner 196 of replacement windshield 170, and measuring a fourth reference distance “D₄” between corner 158 of alignment tool 50 and corner 194 of replacement windshield 170. Although the dimensions D₃ and D₄ have been described relative to corners 156 and 158 of frame 52, it is contemplated that these dimensions may be measured between any of the one or more corners of frame 52 and any of the one or more corners 190, 192, 194, 196 of replacement windshield 170. It is also contemplated that any number of such dimensional measurements may be made between locations on frame 52 and locations on replacement windshield 170. As illustrated in FIG. 11G measurements D₃ and D₄ may be made using, for example, a tape measure. Other measurement methods including, for example, digital instruments, etc., are also contemplated. It may be necessary to adjust the positions of hooks 92 on one of more of first, second, third, and fourth edges 182, 184, 186, 188 to help ensure that distance D₃ is about equal to distance D₁ and that distance D₄ is about equal to distance D₂. Attaching alignment tool 50 to replacement windshield 170 may further include attaching connectors 54 of alignment tool 50 to outer surface 180 of replacement windshield 170.

Method 1000 may include a step of marking the location of device 20 on replacement windshield 170 (Step 1016). Marking the location may include marking an outline of inner perimeter 66 on outer surface 180 of replacement windshield 170. In one exemplary embodiment, a writing instrument (e.g., a marker or sharpie) may be traversed along inner perimeter 66 of frame 52 to draw an outline 206 of inner perimeter 66 on outer surface 180 of replacement windshield 170. FIG. 11H illustrates an exemplary representation of a replacement windshield 170 with outline 206 marked on outer surface 180. It is contemplated that in some exemplary embodiments, marking the location may include creating an outline of inner perimeter 66 on inner surface 208 of replacement windshield 170.

Method 1000 may include a step of detaching alignment tool 50 from replacement windshield 170 (Step 1018). Detaching alignment tools 50 from replacement windshield 170 may include steps similar to those discussed above with respect to step 1012. It is contemplated that when there may be more than one device 20 attached to windshield 16, steps 1014 through 1016 may have to be performed multiple times, using a corresponding separate alignment tool 50 for each device 20. In this exemplary scenario, multiple outlines corresponding to the plurality of devices 20 may be marked on inner surface 208 of replacement windshield 170.

Method 1000 may include a step of assembling replacement windshield 170 to vehicle 10 (Step 1020). Method 1000 may also include a step of attaching device 20 to an inner surface 208 of replacement windshield 170 (Step 1022). Attaching device 20 to replacement windshield 170 may include aligning device 20 such that a perimeter 172 of device 20 generally overlaps outline 206 on outer surface 180 of replacement windshield 170. Method 1000 may allow installation of device 20 on replacement windshield 170 such that a position of device 20 relative to edges 182, 184, 186, and 188 of replacement windshield 170 may correspond to (i.e., be about the same as or equal) to a position of device 20 relative to edges 112, 114, 116, and 118 of windshield 16. Thus, method 1000 may allow installation of replacement windshield 170 and device 20 without the need for reprogramming control system 28 with the position of device 20 on replacement windshield 170. Although method 1000 has been described with respect to alignment tool 50, one of ordinary skill in the art would recognize that similar steps can be implemented for alignment tool 140. It is contemplated that when there may be more than one device 20 attached to windshield 16, step 1022 may have to be performed multiple times, by aligning a corresponding device 20 with its respective outline on replacement windshield 170.

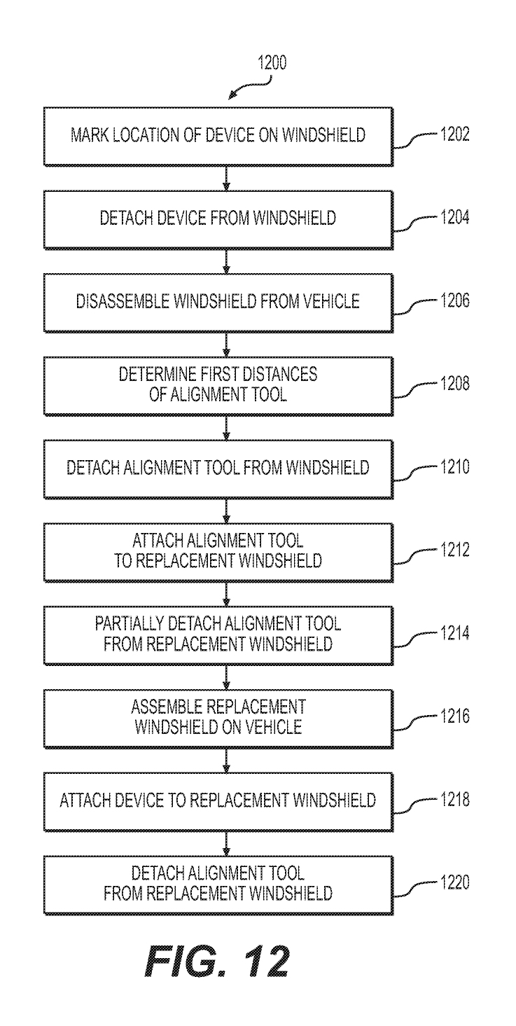

FIG. 12 illustrates an exemplary method 1200 of replacing a windshield 16 having device 20 attached to inner surface 22 with replacement windshield 170, using alignment tool 160. The order and arrangement of steps in method 1200 is provided for purposes of illustration. As will be appreciated from this disclosure, modifications may be made to method 1200 by, for example, adding, combining, removing, and/or rearranging the steps of method 1200.

Method 1200 may include a step of marking the location of device 20 on windshield 16 (Step 1202). Marking the location may include positioning alignment tool 160 on outer surface 24 of windshield 16 so that at least one of fiducial marks 166, 168 may generally overlap with a corresponding similarly shaped fiducial mark on device 20. As used in this disclosure fiducial marks 166, 168 may be deemed to overlap corresponding fiducial marks on device 20, when a distance (i.e. separation), on a surface parallel to outer surface 24 of windshield 16, between the fiducial marks may be less than a fraction of a millimeter or a fraction of an inch. It is contemplated that that an operator may determine whether the fiducial marks overlap based on visual observations. Marking the location may also include firmly attaching frame 142 of alignment tool 160 to outer surface 24 of windshield 16 using connectors 54.

Method 1200 may include a step of detaching device 20 from windshield 16 (Step 1204). Step 1204 may include processes similar to those discussed above with regard to, for example, step 1004 of method 1000. Method 1200 may include a step of disassembling windshield 16 from vehicle 10 (Step 1206). In one exemplary embodiment, windshield 16 may be disassembled from vehicle 10 without detaching alignment tool 160 from outer surface 24 of windshield 16. In another exemplary embodiment, alignment tool 160 may be detached from outer surface 24 of windshield 16 after marking an outline of outer perimeter 164 of alignment tool 160 on outer surface 24 of windshield 16.

Method 1200 may include a step of determining first distances of alignment tool 160 (Step 1208). Step 1208 may include processes similar to those discussed above with regard to, for example, step 1010 of method 1000. Method 1200 may include a step of detaching alignment tool 160 from windshield 16 (Step 1210) and attaching alignment tool 160 to replacement windshield 170 (Step 1212). Steps 1210 and 1212 may include processes similar to those discussed above with respect to, for example, steps 1012 and 1014, respectively, of method 1000.

Method 1200 may include a step of partially detaching alignment tool 160 from replacement windshield 170 (Step 1214). Partially detaching alignment tool 160 may include disconnecting quick disconnect couplers 98 of one or more of first, second, third, and fourth link members 56, 58, 60, 62, and removing hooks 92 of first, second, third, and fourth link members 56, 58, 60, 62 from first, second, third, and fourth edges 182, 184, 186, 188, respectively, of replacement windshield 170. After partially detaching alignment tool 160 from replacement windshield 170, alignment tool 160 may remain attached to outer surface 180 of replacement windshield 170 via connectors 54.

Method 1200 may include a step of assembling replacement windshield 170 to vehicle 10 without detaching connectors 54 of alignment tool 160 from outer surface 180 of replacement windshield 170 (Step 1216). Method 1200 may further include attaching device 20 to inner surface 208 of replacement windshield 170 (Step 1218). Attaching device 20 to inner surface 208 of replacement windshield 170 may include adjusting a position of device 20 such that at least one fiducial mark on device 20 generally overlaps with a corresponding one of fiducial marks 166, 168 on plate 162 of alignment tool 160. Method 1200 may include a step of detaching alignment tool 160 from replacement windshield 170 after assembly of device 20 has been completed (Step 1220). Thus, method 1200 may allow installation of device 20 on replacement windshield 170 such that a position of device 20 relative to edges 182, 184, 186, and 188 of replacement windshield 170 may correspond to a position of device 20 relative to edges 112, 114, 116, and 118 of windshield 16. Method 1200 may allow installation of replacement windshield 170 and device 20 without the need for reprogramming control system 28 with the position of device 20 on replacement windshield 170.

In one exemplary embodiment, step 1212 may include marking a location of alignment tool 140 on replacement windshield 170. Marking the location may include marking an outline of outer perimeter 164 of plate 162 of alignment tool 160 on outer surface 180 of replacement windshield 170. In one exemplary embodiment, a writing instrument (e.g., a marker or sharpie) may be traversed along outer perimeter 164 to draw an outline of outer perimeter 164 on outer surface 180. In this exemplary embodiment, step 1212 may include detaching alignment tool 160 from replacement windshield 170 after marking an outline of alignment tool 160 on outer surface 180 of replacement windshield 170. In this exemplary embodiment, process 1200 may proceed to step 1216 of assembling replacement windshield 170 to vehicle 10 and attaching alignment tool 160 to outer surface 180 of replacement windshield 170 so that outer perimeter 164 of alignment tool 160 generally overlaps outline 206 on replacement windshield 170. After attaching alignment tool 160 to replacement windshield, which has been assembled to vehicle 10, steps 1218 and 1220 may be performed as described above. As discussed above for method 1000, when there are multiple devices 20 attached to windshield 16, steps 1202, 1204, 1208-1214, and 1218-1220 may have to be repeated multiple times, once for each of the plurality of devices 20.

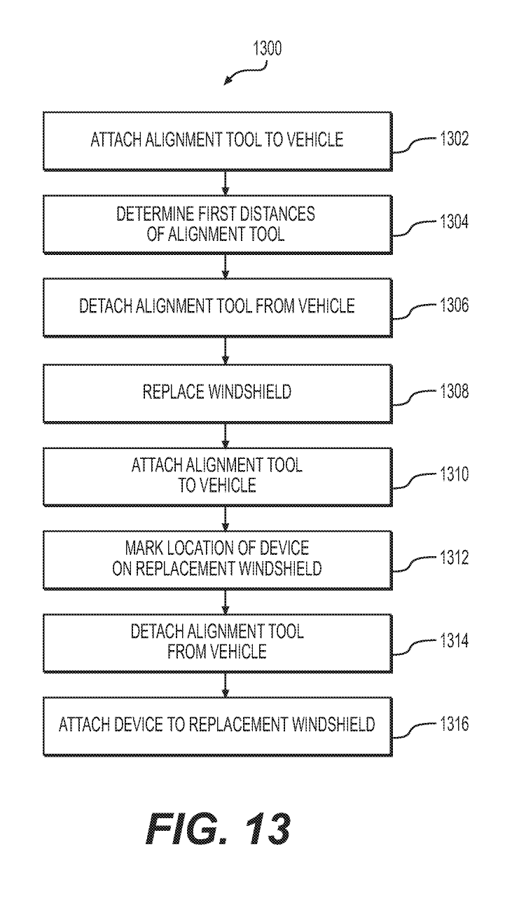

FIG. 13 illustrates an exemplary method 1300 of replacing windshield 16 having device 20 attached to inner surface 22 with a replacement windshield 170, using alignment tool 50. The order and arrangement of steps in method 1300 is provided for purposes of illustration. As will be appreciated from this disclosure, modifications may be made to method 1300 by, for example, adding, combining, removing, and/or rearranging the steps of method 1300.

Method 1300 may include a step of attaching alignment tool 50 to vehicle 10 (Step 1302). Attaching alignment tool 50 to vehicle 10 may include positioning frame 52 such that inner perimeter 66 of opening 64 may overlap or generally overlap with a perimeter 172 of device 20 attached to inner surface 22 of windshield 16. Attaching alignment tool 50 may further include firmly attaching connectors 54 (e.g., suction cups) to outer surface 24 of windshield 16.

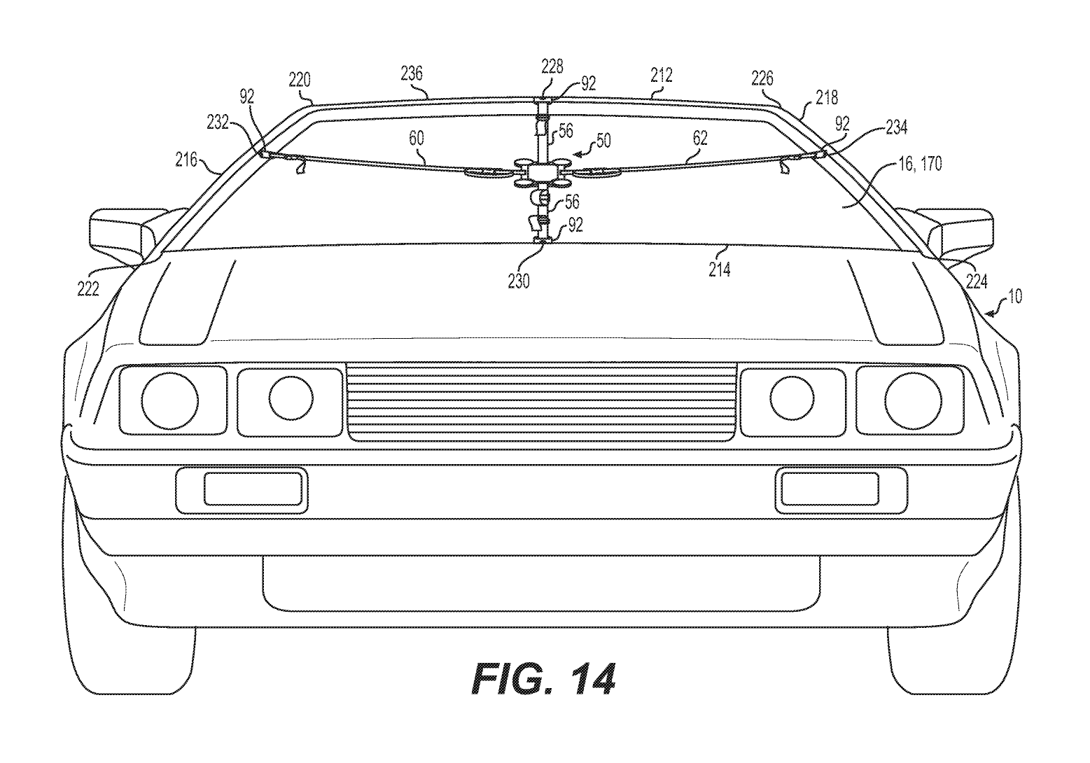

Method 1300 may include a step of determining first distances of alignment tool 50 relative to one or more edges 212, 214, 216, 218 (see FIG. 14), corners 220, 222, 224, 226 (see FIG. 14), and/or positions 228, 230, 232, 234 (see FIG. 14) of body 236 of vehicle 10 (Step 1304). Determining first distances may include attaching edge connection member 92 of first link member 56 to first edge 212 at first position 228, attaching edge connection member 92 of second link member 58 to second edge 214 at second position 230, attaching edge connection member 92 of third link member 60 to third edge 216 at third position 232, and attaching edge connection member 92 of fourth link member 62 to fourth edge 218 at fourth position 234. Edge connection member 92 may be a suction cup, or any other type of connector known in the art that may allow second ends 78, 82, 86, 90 of first, second, third, and fourth link members 56, 58, 60, 62 to be attached to a body 236 of vehicle 10.

FIG. 14 illustrates an exemplary representation of vehicle 10 after edge connection members 92 of first, second, third, and fourth link members 56, 58, 60, 62 have been attached to first, second, third, and fourth edges 212, 214, 216, 218, respectively, of vehicle 10. Determining first distances may include performing processes similar to those discussed above with respect to, for example, step 1010 of method 1000.

Returning to FIG. 13, method 1300 may include a step of detaching alignment tool 50 from vehicle 10 (Step 1306). Detaching alignment tool 50 may include disconnecting quick disconnect couplers 98, detaching edge connection members 92 from first, second, third, and fourth edges 212, 214, 216, 218 of vehicle 10, and releasing connectors 54 from outer surface 24 of windshield 16, without changing the lengths of inner sections 94 and/or outer sections 96 of first, second, third, and fourth link members 56, 58, 60, and 62. It is contemplated that when there may be more than one device 20 attached to windshield 16, steps 1302 through 1306 may have to be performed multiple times, using a separate alignment tool 50 for each device 20. In this exemplary scenario, first distances may be separately determined using the separate alignment tools 50 for each of the plurality of devices 20 attached to windshield 16.

Method 1300 may include a step of replacing windshield 16 with a replacement windshield 170 (Step 1308). Step 1308 may include processes similar to those discussed above with respect to, for example, step 1020 of method 1000. Method 1300 may include a step of re-attaching alignment tool 50 to vehicle 10 after replacement windshield 170 has been assembled on vehicle 10 (Step 1310). Re-attaching alignment tool 50 to vehicle 10 may include processes similar to those discussed above with respect to, for example, step 1302.

Method 1300 may include a step of marking the location of device 20 on replacement windshield 170 (Step 1312). Marking the location of device 20 may include processes similar to those discussed above with respect to, for example, step 1016 of method 1000. Method 1000 may include a step of detaching alignment tool 50 from vehicle 10 (Step 1314). Detaching alignment tool 50 from vehicle 10 may include processes similar to those discussed above with respect to, for example, step 1306. Method 1300 may also include a step of attaching device 20 to an inner surface 208 of replacement windshield 170 (Step 1316). Attaching device 20 to replacement windshield 170 may include aligning device 20 such that a perimeter 172 of device 20 generally overlaps outline 206 on outer surface 180 of replacement windshield 170. Method 1000 may allow installation of device 20 on replacement windshield 170 such that a position of device 20 relative to edges 212, 214, 216, 218 of vehicle 10 may correspond to (i.e., be about the same as or equal) to a position of device 20 relative to edges 112, 114, 116, 118 of windshield 16. Thus, method 1300 may allow installation of replacement windshield 170 and device 20 without the need for reprogramming control system 28 with the position of device 20 on replacement windshield 170. Although method 1300 has been described with respect to alignment tool 50, one of ordinary skill in the art would recognize that similar steps can be implemented for alignment tool 140. It is contemplated that when there may be more than one device 20 attached to windshield 16, steps 1310-1314 may have to be performed multiple times, by aligning a corresponding device 20 with its respective outline on replacement windshield 170.

In another exemplary embodiment, it is contemplated that step 1312 may be eliminated from method 1300. In this exemplary embodiment, step 1316 may be performed before performing step 1314. Thus, for example, in this exemplary embodiment, device 20 may be attached to replacement windshield 170 by aligning device 20 such that a perimeter 172 of device 20 overlaps or generally overlaps inner perimeter 66 of frame 52 of alignment tool 50. Alignment tool 50 may be detached from vehicle 10 using the processes discussed above with respect to, for example, step 1314, after device 20 has been attached to replacement windshield 170. It is contemplated that when there may be more than one device 20 associated with vehicle 10, steps 1316 and 1314 may have to be performed multiple times in that order, using alignment tools 50 having first distances corresponding to a respective device 20, to assemble the multiple devices 20 to replacement windshield 170.

It will be apparent to those skilled in the art that various modifications and variations can be made to the disclosed device alignment tools and the disclosed methods of replacing a windshield with the device alignment tool without departing from the scope of the disclosure. Other embodiments of the disclosed device alignment tools and methods will be apparent to those skilled in the art from consideration of the specification and practice of the device alignment tools and methods disclosed herein. It is intended that the specification and examples be considered as exemplary only, with a true scope of the disclosure being indicated by the following claims and their equivalents.

What is claimed is:

1. An alignment tool, comprising:
a frame;
at least one connector attached to the frame, the at least one connector being configured to releasably attach the frame to an outer surface of a windshield; and
at least one link member fixedly attached to the frame at one end and including an edge connection member at an opposite end, the edge connection member being configured to engage with at least one edge of the windshield, the at least one link member having an adjustable length and being configured to releasably attach the frame to the at least one edge of the windshield.

2. The alignment tool of claim 1, wherein the frame is annular and includes an opening.

3. The alignment tool of claim 2, wherein the opening has at least one of a rectangular shape, a square shape, a circular shape, or an elliptical shape.

4. The alignment tool of claim 1, wherein the at least one connector includes a suction cup, and the suction cup includes:
a first end attached to the frame; and
a second end configured to be attached to the outer surface of the windshield.

5. The alignment tool of claim 1, wherein the edge connection member is a hook.

6. The alignment tool of claim 1, wherein the at least one link member includes:
an inner section fixedly attached to the frame at a first end of the at least one link member;
an outer section attached to the edge connection member at a second end of the at least one link member; and
a coupler connecting the inner section and the outer section.

7. The alignment tool of claim 6, wherein at least one of the inner section and the outer section has a fixed length.

8. The alignment tool of claim 1, wherein the at least one link member includes:
a first link member including a first inner end connected to the frame and a first outer end connected to a first hook;
a second link member including a second inner end connected to the frame and a second outer end connected to a second hook;
a third link member including a third inner end connected to the frame and a third outer end connected to a third hook; and
a fourth link member including a fourth inner end connected to the frame and a fourth outer end connected to a fourth hook, wherein each of the second link member, the third link member, and the fourth link member also includes a pair of link member sections connected by a quick disconnect coupler.

9. The alignment tool of claim 8, wherein the pair of link member sections includes:
a variable length section extending from the frame to the quick disconnect coupler; and
a fixed length section extending from the quick disconnect coupler to one of the second hook, the third hook, and the fourth hook.

10. A method of relocating a device, comprising:
making a first mark on an outer surface of a windshield of a vehicle, the first mark corresponding to a position of the device attached to an inner surface of the windshield;
disassembling the windshield from the vehicle;
positioning an alignment tool on the outer surface of the windshield at a first location corresponding to the first mark;
determining one or more first distances of the alignment tool relative to first edges of the windshield;
positioning the alignment tool at a second location on a replacement windshield such that one or more second distances of the alignment tool from second edges of the replacement windshield are about equal to the one or more first distances;
making a second mark on the replacement windshield, the second mark corresponding to the second location of the alignment tool;
assembling the replacement windshield on the vehicle; and
attaching the device to the replacement windshield based on the second mark.

11. The method of claim 10, wherein the device is a camera and the method further includes
detaching the camera from the windshield before disassembling the windshield from the vehicle.

12. The method of claim 10, wherein the alignment tool includes an annular frame, and making the first mark includes:
attaching the frame to the windshield such that an opening in the frame generally overlaps with a perimeter of the device attached to the windshield;
marking on the outer surface of the windshield an outline of the frame; and
detaching the frame from the windshield.

13. The method of claim 12, wherein positioning the alignment tool at the first location includes attaching the frame to the outer surface of the windshield such that the opening in the frame generally overlaps with the outline traced on the windshield.

14. The method of claim 10, wherein the alignment tool includes a frame, a first link member, a second link member, and a third link member attached to the frame, and determining the one or more first distances includes:
attaching a first free end of the first link member to a first position on the windshield;
attaching a second free end of the second link member to a second position on the windshield;
attaching a third free end of the third link member to a third position on the windshield; and
adjusting lengths of the first link member, the second link member, and the third link member such that there is no slack in any of the first link member, the second link member, and the third link member.

15. The method of claim 14, wherein the first position is located on a first edge of the windshield and at least one of the second position and the third position is located on a second edge different from the first edge.

16. The method of claim 15, wherein each of the second link member and the third link member includes a pair of sections connected by a coupler, and positioning the alignment tool at the second position includes:
disconnecting a corresponding coupler to separate the pair of sections of each of the second link member and the third link member;
detaching the first free end, the second free end, and the third free end;
detaching the frame from the windshield;
placing the frame on the replacement windshield;
attaching the first free end, the second free end, and the third free end to the replacement windshield;
connecting the pair of sections of each of the second link member and the third link member by engaging the corresponding coupler; and
adjusting the positions of the first free end, the second free end, and the third free end such that there is no slack in the first link member, the second link member, and the third link member.

17. The method of claim 16, wherein making the second mark, further includes:
tracing on an outer surface of the replacement windshield an outline of the frame; and
detaching the frame from the replacement windshield.

18. The method of claim 17, wherein attaching the device to the replacement windshield, further includes:
positioning the device on the inner surface of the replacement windshield such that a perimeter of the device generally overlaps with the outline of the frame; and
attaching the device to the replacement windshield.

19. The method of claim 14, wherein the alignment tool includes a fourth link member attached to the frame, and determining the one or more first distances includes attaching a fourth free end of the fourth link member to a fourth position on the windshield, wherein
the first position is located on a first edge of the windshield,
the second position is located on a second edge of the windshield opposite the first edge,
the third position is located on a third edge of the windshield, the third edge extending between the first edge and the second edge, and
the fourth position is located on a fourth edge of the windshield disposed opposite the third edge.

20. The method of claim 19, wherein determining the one or more first distances further includes:
measuring a first distance of the frame from a first corner of the windshield, the first corner being common to the first edge and the third edge; and
measuring a second distance of the frame from a second corner of the windshield, the second corner being common to the second edge and the third edge.

21. A method of relocating a camera, comprising:
making a first mark on an outer surface of a windshield of a vehicle, the first mark corresponding to a position of the camera attached to an inner surface of the windshield;
disassembling the windshield from the vehicle;
positioning an alignment tool on the outer surface of the windshield at a first location corresponding to the first mark;
determining one or more first distances of the alignment tool relative to first edges of the windshield;
positioning the alignment tool at a second location on a replacement windshield such that one or more second distances of the alignment tool from second edges of the replacement windshield are about equal to the one or more first distances;
making a second mark on the replacement windshield, the second mark corresponding to the second location of the alignment tool;
assembling the replacement windshield on the vehicle; and
attaching the camera to the replacement windshield based on the second mark.
